(19) United States
(12) Patent Application Publication
(10) Pub. No.: US 2006/0196938 A1
(43) Pub. Date: Sep. 7, 2006

(54) Voting system with operating possibility for disabled persons, and use of such system

(76) Inventors: Johannes Bernardus A. Van Wijk, Bennekom (NL); Johannes Harm. L Hogen Esch, Aalten (NL)

Correspondence Address: JACOBSON HOLMAN PLLC, 400 SEVENTH STREET N.W., SUITE 600, WASHINGTON, DC, 20004, US

(21) Appl. No.: 10/540,484

(22) PCT Filed: Dec. 24, 2003
(86) PCT No.: PCT/NL03/00939

§ 371 Date: Jan. 19, 2006

(30) Foreign Application Priority Data
Dec. 24, 2002 (NL) 1022261

(51) Int. Cl. G07C 13/00

(52) U.S. Cl. 235/386

(57) ABSTRACT

A voting system with operating possibility for disabled persons, wherein additional operating functions (4, 5, 7, 8) for persons with a physical disability are located at or near a front side (F) of the system. In addition, the invention provides a use of such a system to vote for candidates during elections.

The invention relates to a voting system with operating possibility for disabled persons.

From practice, a so-called “full-face” voting machine is known. This machine shows all options in substantially one operating field, this in contrast to a voting system for a so-called multi-stage voting method. In a multi-stage voting system, for instance, first a party is chosen and then, using the same operating field, a candidate is chosen.

A drawback of aforementioned “full-face” voting system or voting machine is that, with a large number of candidates, the operating field of such a machine is rather large, so that it is difficult to access for persons with a physical disability. Existing systems sometimes have a provision for this whereby the height of the whole machine can be adjusted, but, in many cases, this does not offer a satisfactory solution because the key field is rather wide and the upper keys still cannot be reached and also because these machines are rather heavy and therefore difficult to adjust.

The invention contemplates an improvement of the voting system. In particular, the invention contemplates a voting system by means of which disabled persons can easily vote.

For this purpose, according to the invention, the voting system is characterized in that additional operating functions for persons with a physical handicap are located at or near a front side of the system.

In this manner, disabled persons can relatively easily cast their vote during use of the system. Disabled persons can easily use additional operating functions located at or near the front side of the system.

In particular, these additional operating functions are easy to access for disabled persons, at the front of the voting system. Preferably, substantially all selections to be made for choosing a candidate can be carried out by operating these operating functions. The operating functions may, for instance, comprise at least one selector, navigator, joystick and/or arrow keys, or the like. The selection made may, for instance, be indicated on a candidate field by a light source, for instance an LED or the like.

According to a further embodiment of the invention, the selector comprises a keyboard, for instance an alphanumeric keyboard and/or numeric keyboard.

By means of a keyboard, a selection of one or several candidates to be chosen can be carried out simply. For instance, coordinates of a candidate field to be chosen can be entered by means of the keyboard to thus select one or more desired candidates. In addition, by means of the keyboard, for instance, according to the American voting system, one or more candidates not listed can be voted for.

According to a further embodiment of the invention, the system is provided with a language selector, for instance a language key, to choose a language, for instance the language in which operating instructions are shown on a display of the system.

According to a further embodiment of the invention, the system is provided with one or more Braille keys for operation by visually disabled persons.

Such Braille keys may, for instance, be provided with Braille symbols. The system may further be provided with, for instance, a voice-response system and/or headphone for the purpose of operating the voting system. By means of one or more Braille keys, a voice-response system and/or headphone, the system can be properly and clearly operated by, for instance, visually disabled persons.

Further elaborations of the invention are described in the subclaims.

The invention will now be elucidated on the basis of an exemplary embodiment and with reference to the drawing, in which:

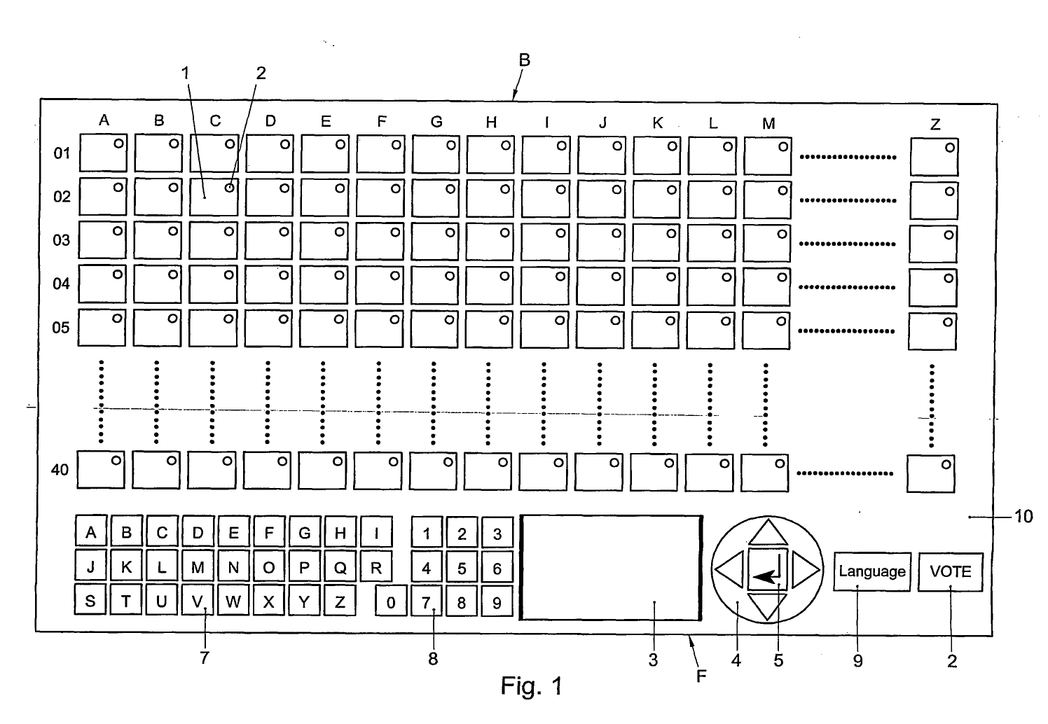

FIG. 1 diagrammatically shows a top plan view of an exemplary embodiment of the invention.

FIG. 1 diagrammatically shows an exemplary embodiment of a voting system according to the invention. The system is provided with regular operating functions (A-Z, 01-40, 2) to regularly vote for at least one candidate. The exemplary embodiment is further provided with additional operating functions (4, 5, 7, 8) for persons with a physical disability. The regular operating functions are provided with regular selection functions, at least one operating field (A-Z, 01-40), to select at least one candidate. The additional operating functions (4, 5, 7, 8) are also designed for selecting at least one candidate. The additional operating functions are preferably redundant with respect to the regular selection functions.

The regular operating functions are provided with other regular operating functions (2), at least one voting key (2), to cast a vote for at least one selected candidate. The voting key (2) is no additional operating function. The other regular operating functions (2) are, in particular, also needed to cast a vote in combination with the additional operating functions (4, 5, 7, 8). As the Figure shows, the additional operating functions (4, 5, 7, 8) and the other regular operating functions (2) are located at or near the front side (F) of the system.

The exemplary embodiment particularly comprises a “full-face” voting machine, in which the options for the candidates in the operating field are grouped, at least arranged in columns (A-Z) and rows (01-40). The columns (A-Z) of the operating field represent, for instance, different parties, while the rows (01-40) represent the candidates of the respective parties. On the other hand, the columns (A-Z) may, for instance, represent different candidates, while the rows (01-40) represent the respective parties. Further, a vote for a candidate may, for instance, be a vote for a corresponding party.

The operating field may, for instance, be provided by candidate fields, voting keys, switches or the like, which are arranged in columns and rows, and are selectable or manually operable. During use, all options, at least the candidate fields (A-Z, 01-40) of all candidates eligible for election, are shown in the same operating field at the same time. The operating field is, for instance, provided on or in a top side of a voting table (10) or the like. In the top right corner of each candidate field, a light (6) or the like is provided, for instance in the form of an LED (Light Emitting Diode), so that it can be determined which option field is active, at least is selected.

The system is further provided with a display (3) to show information, for instance operating instructions and/or information concerning the chosen or selected candidate. The display (3) has, for instance, been provided on or in the voting table (10) and extends next to the operating field (A-Z, 01-40). The system further comprises, for instance, a control (not shown), for instance one or more computers, regulating electronics or the like. The operating field, the voting key, the display and the like can, for instance, be regulated, read out and the like by the control, for the purpose of a desired operation of the system. It will be clear to a skilled person how such a control may be designed.

During use, a user can operate the candidate field (1) of a particular column (C) and row (02), for instance by pressing on that candidate field (1) to select the corresponding candidate. Then, the user can vote for the selected candidate (C, 02) by operating the voting key (2).

The display (3), on which, for instance, operating instructions and a chosen candidate are shown, as well as the voting key (2), are provided at the bottom of the operating field, at least at or near a front side (F) of the voting table (10). In this manner, the display (3) and the voting key (2) are well accessible to persons with a physical disability, this in contrast to current systems, in which these elements are provided at the top of the field, at least near a back side (B).

Further, this voting machine is additionally provided with selectors (4, 5, 7,8) for the benefit of persons with a physical disability. The selectors are intended for, during use, carrying out substantially all selections to be made for choosing candidates. One of the selectors comprises a navigator (4). This navigator may be designed in different manners, and, for instance, comprise a so-called joystick or the like. In the exemplary embodiment, the navigator (4) comprises five keys, consisting in four arrow keys and a central enter key (5). The navigator (4) is provided near the front side (F) of the system, in particular on the voting table (10). These additional operating functions (4, 5) are located substantially between the front side (F) and the operating field (A-Z, 01-40).

During use, the joystick and/or the arrow keys (4) can be used to move through the columns and rows of the operating field (A-M, 01-40) to activate the option field (1) of each candidate to be chosen. When an option field (1) has been reached by operation of the navigator (4), the corresponding LED (6) of the candidate field (1), for instance, starts to flash. Then, the option field is not fixed yet, but only selected. By subsequently pressing, for instance, the joystick and/or the central enter key (5), this option, at least the selected candidate field, can be fixed. The corresponding LED (6) can then, for instance, be continuously lighted to confirm the fixation of the candidate. Then, a vote can be cast for the candidate corresponding to the fixed candidate field by pressing the voting key (2).

Preferably, the system is designed such that a choice already made can be revoked or changed before the vote is cast via the voting key (2). Canceling a selection of a candidate field may, for instance, be done by selecting that candidate field again, for instance by means of the selector, before the voting key (2) is operated.

Because the navigator, at least the joystick and/or the arrow keys (4) and enter key (5), is placed at or near the front side (F) of the machine, these additional operating means are well accessible to physically disabled persons. Because the voting key (2) is placed at the front side of the machine, the voting key (2) is also well accessible to persons with a physical disability.

In addition to the joystick or arrow keys (4), the exemplary embodiment is provided with a selector to directly enter coordinates of a candidate field (1) to be chosen. In the present exemplary embodiment, for this purpose, a selector, comprising an alphanumeric keyboard (7) and a numeric keyboard (8), is provided. During use, the coordinates of a candidate field to be chosen can be entered by means of these keyboards (7, 8) to select a desired candidate. These keyboards (7, 8) are located at or near the front side (F) of the machine and are thus well accessible to disabled persons.

Preferably, the LED (6) of a candidate field (1) selected by means of the keyboards (7, 8) starts to flash, at least after the corresponding coordinates (C, 02) have been entered, to indicate the selected candidate field (1). Using an alphanumeric keyboard (7) has the further advantage that the machine is also suitable for, for instance, the American system of “write-in” votes, in which, also, a vote can be cast for a candidate not listed.

Depending on the nature of the physical disability, the voter can determine which of the methods is the best for him or her. The selection method in which coordinates are entered by means of the alphanumeric keyboard (7) and the numeric keyboard (8) can be carried relatively rapidly, in particular compared to the method with the joystick or the arrow keys. Voters without a disability can, of course, directly press the candidate field (1) to be chosen to activate their choice in this manner.

Further, the system may, for instance, be provided with a language key (9) or similar language selector, by means of which the language in which operating instructions are shown on the display (3) can be changed.

For the benefit of persons with a visual disability, the alphanumeric operating keys (7) and the numeric operating keys (8) may, for instance, each further be provided with a corresponding Braille symbol. In addition, the system may, for instance be provided with a so-called voice-response system, for instance a headphone, to convey, in oral form, the operating instructions and/or the chosen party and candidate to a user.

Preferably, the voting system is designed for casting multiple votes per election. For instance, the joystick, arrow keys (4), enter key (5) and/or a keyboard (7, 8) can be used for successively reaching and selecting the desired candidate fields. After reaching each desired candidate field, the corresponding LED, for instance, starts to flash. The candidate field reached can then, for instance, be fixed by operating the enter key (5) and/or pressing the joystick, so that the corresponding LED, for instance, is continuously lighted. In this manner, all desired candidate fields can be selected, such that, for instance, all corresponding LEDs (6) have been brought in a continuously lighted condition. Then, the voting key (2) can be operated to confirm all choices made, so that the vote is cast. The system can then, for instance, be designed to revoke or change a choice already made by again selecting a candidate already chosen, before the voting key (2) is operated.

It will be clear that the invention is not limited to the exemplary embodiment described. Various modifications are possible within the scope of the invention as it is set forth in the following claims.

For instance, the system may be designed for voting for different candidates, persons, parties and/or the like. The system may, for instance, be used for various types of elections, for instance political elections or other elections.

1. A voting system provided with regular operating functions to regularly vote for at least one candidate and provided with additional operating functions located at or near a front side of the system for persons with a physical disability wherein the additional operating functions are designed for selecting at least one candidate wherein the regular operating functions are provided with regular selection functions to select at least one candidate and other regular operating functions to cast a vote for at least one selected candidate wherein the other regular operating functions are also needed to cast a vote in combination with the additional operating functions wherein the regular selection functions are provided with an operating field with candidate fields for showing substantially all candidates eligible for election at the same time wherein each candidate field is manually operable for selecting a corresponding candidate and wherein the additional operating functions are provided with at least one selector for carrying out, in use, substantially all selections to be made for choosing a candidate, wherein the at least one selector is located at or near the front side of the voting system and wherein the at least one selector comprises a navigator, for instance a joystick or arrow keys and wherein the other regular operating functions comprise at least one voting key for casting a vote for at least one selected candidate said at least one voting key being also provided near and/or at the front side of the voting system.

2. The system according to claim 1, wherein the at least one selector further comprises at least one keyboard, for instance an alphanumeric keyboard and/or numeric keyboard.

3. The system according to claim 2, wherein, during use, coordinates of the candidate field to be chosen can be entered by means of said keyboard to select a desired candidate.

4. The system according to claim 1, provided with a number of light sources to indicate a selection made by means of the additional operating functions.

5. The system according to claim 4, wherein each candidate field is provided with a said light source.

6. The system according to claim 4, wherein said light source comprises at least one light and/or at least one LED.

7. The system according to claim 5, designed to make the light source of a selected, but not yet fixed candidate field flash during use.

8. The system according to claim 5, designed to cause the light source of a selected, but not yet fixed candidate field to be continuously lighted during use.

9. The system according to claim 1, provided with at least one display located at or near the front side of the voting system, for instance to show operating instructions and/or information regarding a selected candidate.

10. The system according to claim 1, wherein the system is provided with a language selector, for instance a language key, to chose a language, for instance the language in which operating instruction are shown on a display of the system, wherein the language selector is preferably located at or near said front side.

11. The system according to claim 1, wherein one or more operating keys of the system are provided with Braille symbols for operation by visually disabled persons.

12. The system according to claim 1, provided with a voice-response system and/or headphone for the purpose of operation of the voting system.

13. The system according to claim 1, designed for casting several votes per election.

14. The system according to claim 2, wherein, during use, by means of operation of the alphanumeric keyboard, so-called “write-in” votes, at least votes for a candidate not listed, can be cast.

15. The system according to claim 1, wherein the candidate fields are arranged in columns and rows.

16. The system according to claim 1, wherein said additional operating functions are located substantially between said front side and the said operating field.

17. The system according to claim 1, wherein the additional operating functions and the other regular operating functions are located at or near the front side of the system.

18. The system according to claim 1, wherein the regular selection functions are located at a distance from the front side of the system.

19. The system according to claim 1, wherein the additional operating functions are located substantially between the front side of the system and the regular selection functions.

20. The system according to claim 1, wherein the additional operating functions are redundant with respect to the regular selection functions.

21. The system according to claim 1, provided with a voting table, wherein the voting table comprises the candidate fields and operating functions, wherein the operating functions comprise the regular operating functions and the additional operating functions.

22. The system according to claim 1, wherein the candidate fields are located behind the additional operating functions for disabled persons, viewed from the front side of the system.

23. The system according to claim 1, wherein regular operating functions are substantially all located behind the additional operating functions, viewed from the front side of the system.

24. The system according to claim 1, comprising a full-face voting system.

25. Use of a system according to claim 1 to vote for candidates during elections.
